(19) United States
(12) Patent Application Publication
(10) Pub. No.: US 2018/0302699 A1
(43) Pub. Date: Oct. 18, 2018

(54) Multi-Purpose Removable Adaptor Base

(71) Applicant: Alejandro Bassi, Carmel By The Sea, CA (US)

(72) Inventor: Alejandro Bassi, Carmel By The Sea, CA (US)

(21) Appl. No.: 15/944,758

(22) Filed: Apr. 3, 2018

Related U.S. Application Data
(60) Provisional application No. 62/601,868, filed on Apr. 4, 2017.

(51) Int. Cl. H04R 1/02; F16M 13/02; G10G 7/00

(52) U.S. Cl. CPC H04R 1/02; G10G 7/00; F16M 13/02

(57) ABSTRACT

The present invention is directed to a multi-purpose removable adaptor base comprising an apparatus base which connects to a surface and allows such to be attached to a removable adaptor which in turn attaches to a microphone arm or any suitable object. The apparatus will further attach to a surface of musical instrument

### CROSS-REFERRENCE TO RELATED APPLICATIONS

The present application claims the benefit of U.S. Provisional application Ser. No. 62/601,868, incorporated by reference herein and for which benefit of the priority date is hereby claimed.

### FIELD OF INVENTION

The present invention generally relates to adaptor devices that receive and support a microphone and microphone arm, or more particularly to an apparatus for the holding and stabilization of a microphone and microphone arm.

### BACKGROUND OF THE INVENTION

The conventional microphone stands have been used by all musicians throughout history in multiple settings including stage performances, studio recordings, studio music table recordings and many other settings. These types of stands require more space for setup. The stands further tend to be heavy, large and uncomfortable to carry, making packing and travel with such stands much more difficult.

The multi-purpose removable adaptor base was created to discard with the inconveniences that regular microphone stands cause in their use as they currently exist. This invention provides a way to attach an arm including but not limited to an extension microphone arm to a surface including but not limited to an instrument surface creating simplicity and comfort during stage performance, studio recordings, music table recordings as well as portability in the travel/moving process.

### SUMMARY OF THE INVENTION

The multi-purpose removable adaptor base is an adaptor base, which attaches to a surface including but not limited to music instruments to support an arm such as but not limited to a microphone arm through a removable adaptor. The removable adaptor provides the means by which such arm is removable attached to the adaptor base. Generally the present invention supports one arm. In another embodiment, the apparatus can support multiple arms.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side view diagram of a multi-purpose removable adaptor base.

FIG. 2 is an oblique top view of a multi-purpose removable adaptor base.

FIG. 3 is a bottom view of a multi-purpose removable adaptor base.

FIG. 4 is an oblique exploded top view of a multi-purpose removable adaptor base.

FIG. 5 is an oblique exploded view of a removable adaptor.

FIG. 6 is an oblique view of a removable adaptor.

FIG. 7 is an oblique view of an elongated removable adaptor.

FIG. 8 is an oblique exploded top view of an adaptor base.

FIG. 9 is an oblique top view of an adaptor base attached to a suitable surface.

FIG. 10 is an oblique top view of an adaptor base attached to a thin surface.

FIG. 11 is a diagonal side view of multi-purpose removable adaptor base displayed on a guitar.

FIG. 12 is a top side view of a multi-purpose removable adaptor base with an elongated side wing displayed on a guitar.

### DETAILED DESCRIPTION

Before the invention is described in further detail, it is to be understood that the invention is not limited to the particular embodiments describe, as such may, of course, vary. It is also to be understood that the terminology used herein is for the purpose of describing particular embodiments only, and not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be use in the practice or testing of the present invention, a limited number of the exemplary methods and materials are described herein.

It must be noted that as used herein and in the appended claims, the singular forms “a”, “an”, and “the” include plural referents unless the context clearly dictates otherwise. All publications mentioned herein are incorporated herein by reference to disclose and describe the methods and/or materials in connection with whit the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

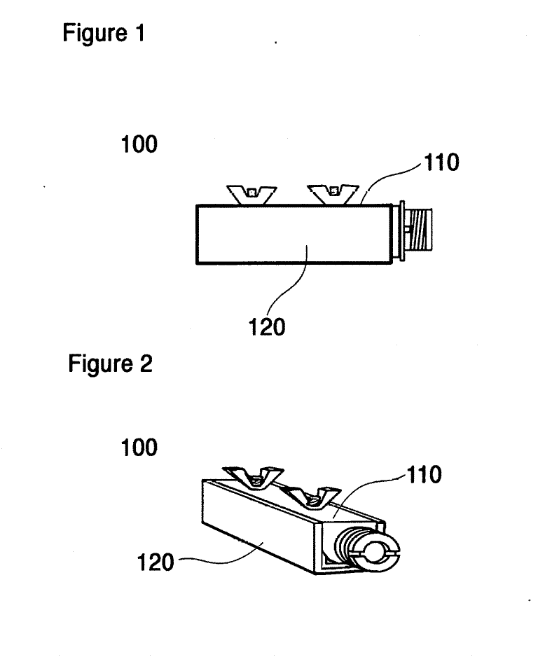

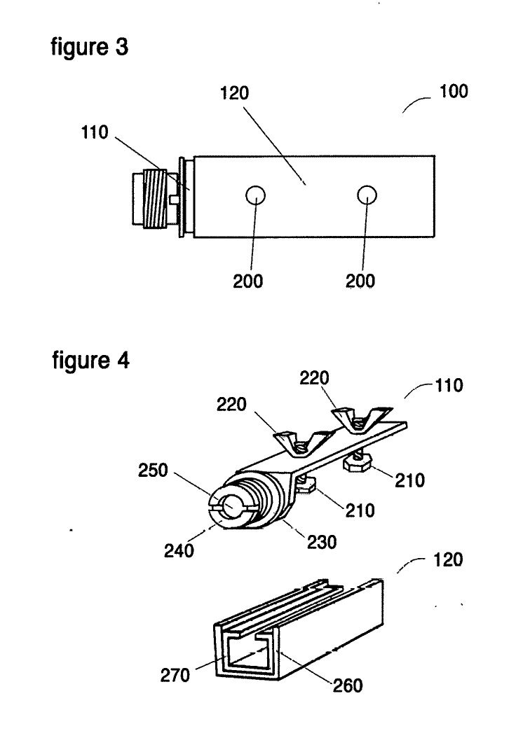

The present invention provides an apparatus, which attaches to a surface allowing for an arm to be removably attached to a base through a removable adaptor. FIG. 1 shows a preferred embodiment of the present invention, a multi-purpose removable adaptor base 100 comprising a removable adaptor 110 which may be made of metal, wood, polycarbonate polymer or other suitable material, along with an adaptor base 120 which may be made of metal, wood, polycarbonate polymer or other suitable material. In FIG. 2 is shown an oblique top view of a multi-purpose removable adaptor base 100 comprising of a removable adaptor 110 along with an adaptor base 120. Turning now to FIG. 3, shown is a bottom view of a multi-purpose removable adaptor base 100 comprising a removable adaptor 110 along with an adaptor base 120, showing plurality of holes 200 appearing on the bottom of the adaptor base 120, through which the adaptor base 120 is attached to a suitable surface with the use of screws.

Turning now to FIG. 4, shown is an oblique exploded top view of a multi-purpose removable adaptor base 100 comprising a removable adaptor 110 configured to glide in and attach to an adaptor base 120 with a plurality of head bolts 210 and a plurality of nuts 220. The removable adaptor 110 comprising a washer 230 that goes into male screw 250. Male screw 250 receives a male to female adaptor 240. Additionally, adaptor base 120 comprising a receiver base 260 which receives a T track 270 allowing for a removable adaptor 110 to glide into the adaptor base 120 through the plurality heat bolts 210, to be secured through a plurality of nuts 220.

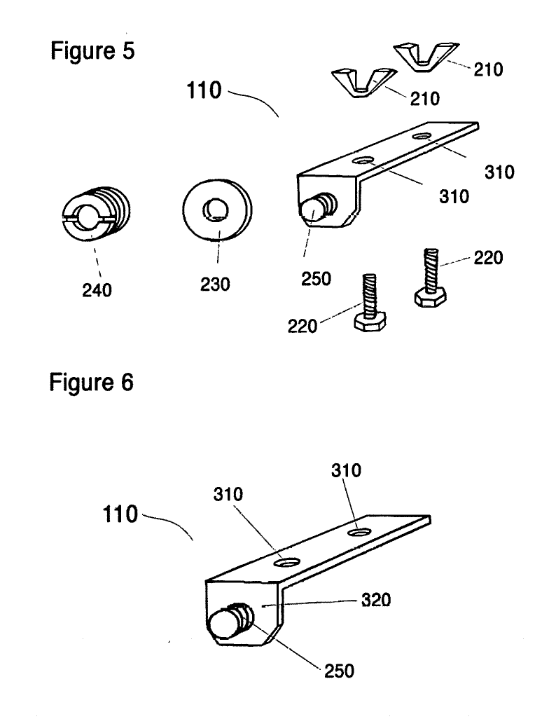

Turning now to FIG. 5, shown is an oblique exploded top view of a removable adaptor 110 comprising plurality of holes 310 through which a plurality of head bolts 220 come through removable adaptor 110. Plurality of head bolts 220 and plurality of nuts 210 make possible to glide and secure removable adaptor 110 through an adaptor base 120. Removable adaptor 110 additionally comprising male to female adaptor 240, washer 230 and screw 250 that is securely attached, slide in, or screwed into removable adaptor 110. Turning now to FIG. 6, shown is an oblique view of removable adaptor 110 with side wing 320 comprising plurality of holes 310, and screw 250. The screw 250 securely attaches, slides in, or screws into removable adaptor 110 through side wing 320.

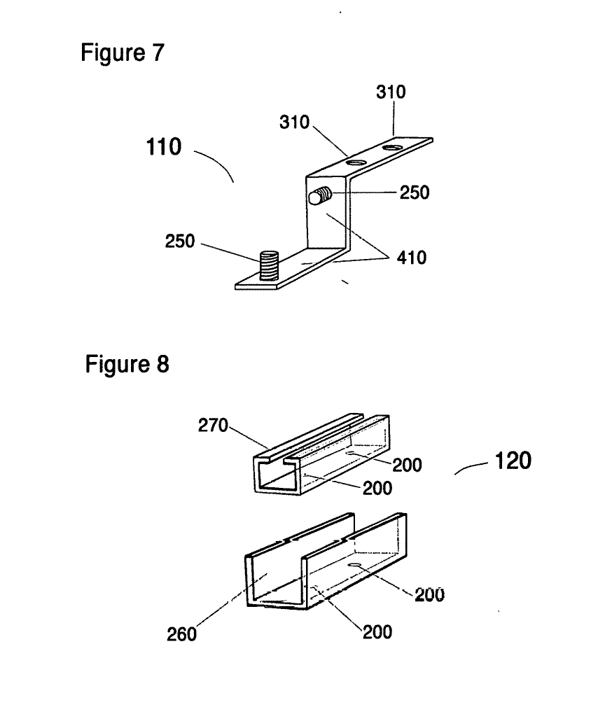

Turning now to FIG. 7, shown is an oblique top view diagram showing removable adaptor 110 with elongated side wing 410, comprising plurality of screws 250, plurality of holes 310. Plurality of screws 250 securely attach, slide in, or screw into removable adaptor 110 through elongated side wing 410.

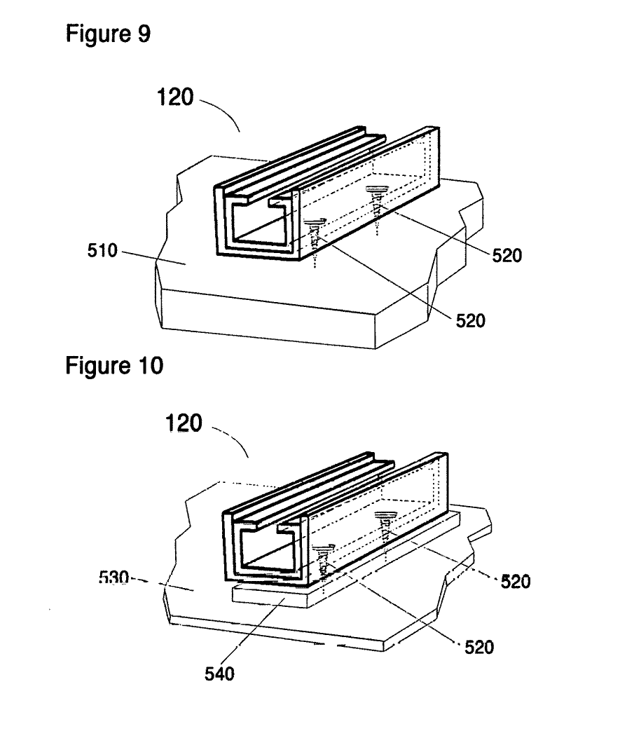

Turning now to FIG. 8, shown is an oblique exploded top view of an adaptor base 120 comprising a receiver base 260 which receives a T track 270. Additionally, plurality of holes 200 provides the means for screws to be inserted from top of T track 270 into the bottom of receiver base 260 allowing for adaptor base 120 to attach to a suitable surface. Turning now to FIG. 9, shown is an oblique top view of an adaptor base 120 of a multi-purpose removable adaptor base 100 attached to a suitable surface 510 through plurality of screws 520.

Turning now to FIG. 10, shown is an oblique top view of an adaptor base 120 attached to a thin surface 530 with use of support base 540 and plurality of screws 520. Support base 540 is a mechanism which provides means to support the multi-purpose removable adaptor base 100 when adaptor base 120 is attached to thinner surfaces including, but not limited to, a thin instrument surface such as, but not limited to, acoustic guitar, acoustic base, charango and other thinner surface objects. Additionally, thin surface 530 operates as the connecting factor between support base 540 and adaptor base 120.

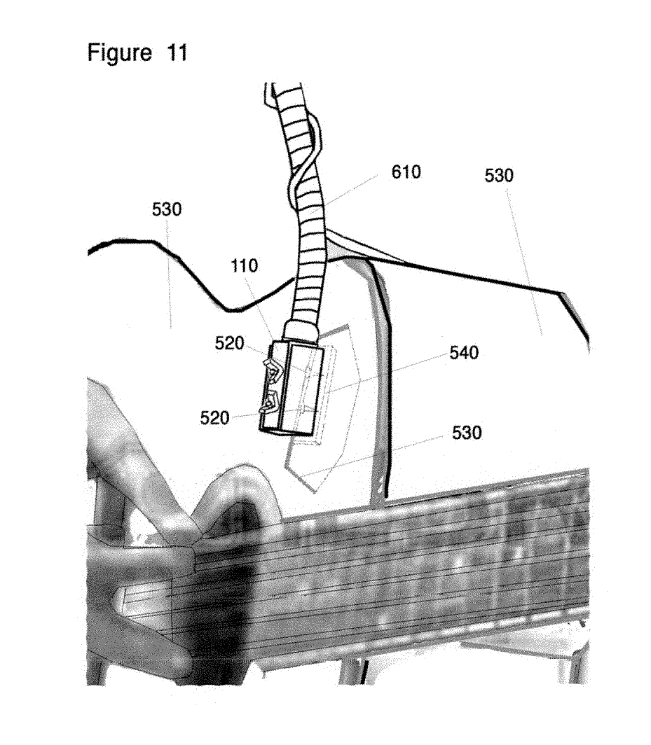

Turning now to FIG. 11, shown is a top side view of a multi-purpose removable adaptor base 100 displayed on a thin surface 530, comprising support base 540 and plurality of screws 520. Additionally showing an attached flexible microphone extension arm 610 attached to removable adaptor 110.

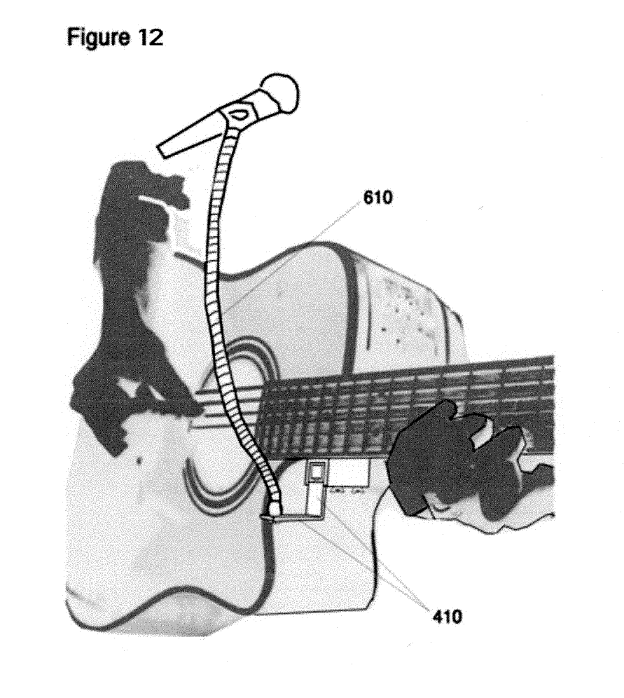

Turning now to FIG. 12, shown is a diagonal side view of multi-purpose removable adaptor base 100 with elongated side wing 410 of the removable adaptor 110 displayed under the neck in between the neck and the body of a guitar, showing an attached flexible microphone extension arm 610 attached to the elongated side wing 410 of the removable adaptor 110.

What is claimed is:

1. A multi-purpose removable adaptor base apparatus comprising: a. an apparatus base with a plurality of secured mechanisms configured to attach to a surface; b. a removable apparatus with a plurality of secured mechanisms and plurality of adaptors; Wherein said apparatus base receives said removable apparatus through said secured mechanisms.

2. The apparatus of claim 1, comprising of a removable apparatus wherein each said adaptors connect to a suitable object.
